(19) United States
(12) Patent Application Publication
(10) Pub. No.: US 2006/0241795 A1
(43) Pub. Date: Oct. 26, 2006

(54) Networked, electronic game tournament method and system

(76) Inventors: Gary Weingardt, Las Vegas, NV (US); Gamin Weingardt, Las Vegas, NV (US)

Correspondence Address: WEISS & MOY PC, 4204 NORTH BROWN AVENUE, SCOTTSDALE, AZ, 85251, US

(21) Appl. No.: 11/112,291

(22) Filed: Apr. 22, 2005

(51) Int. Cl. G06F 19/00

(52) U.S. Cl. 700/91

(57) ABSTRACT

A method and a system for a electronic gaming tournament system in which many remotely located players participate in a gaming tournament. The tournament may have various tiers of participation according to the skill and/or luck of the player. The players may be separated into at least two groups, the challengers and the defenders. The challengers try to win enough games and/or skill sets to be classified as a defender at specific tier levels of a multi-tiered ladder within the tournament. In one embodiment, the defenders receive consideration to defend against the challengers. Based on established criteria, a challenger may qualify to advance to a tier within the ladder. A plurality of multi-tiered ladders may be provided, and play between ranked players from different ladders facilitated. The system may include software and hardware to implement the method steps.

### FIELD OF THE INVENTION

The present invention relates generally to games, and more particularly to online interactive electronic games, and their use in tournament play.

### BACKGROUND OF THE INVENTION

Competitive games are a popular form of recreation. Competitive games consume a large portion of our free time. Whether watching or participating, the allure is undeniable. In addition to the competitive sports, intellectual competitions such as chess or bridge tournaments are also popular.

These competitions remain popular because whether a participant or spectator, one is involved. They require people to meet at a central location and specific time, providing a sense of community and camaraderie, as well as a place to socialize. A typical chess tournament, for example, might have fifty players meeting at a central playing site.

Such tournaments and competitions suffer from several drawbacks, however, as participants may have to travel considerable distance to get to the playing site and may require expensive overnight accommodations when the tournament lasts more than one day. The start times for most tournaments must also be fixed in advance. The chess players, for example, might meet at 9:00 AM for the start of the first round. This forces all participants to adhere to the same schedule, an increasingly difficult proposition in today's busy world. Furthermore, facilities used to host the tournament, such as hotel meeting rooms, banquet halls, and auditoriums, represent a significant expense to the tournament organizers.

Tournaments geared to a narrower subset of tournament players (niche-tournaments) are often economically unfeasible because of the high costs associated with obtaining playing facilities. While it may be possible to hold a martial arts tournament in a city, it may be hard to hold a tournament for a specific subset to the martial arts such as Aikido. The few players that would participate would not justify the cost of the facilities.

Electronic tournaments allow participants to “meet” in cyberspace, competing at a virtual location accessible to any player at any time. Because no travel is required, many of the disadvantages of physical tournaments are eliminated, while maintaining the sense of camaraderie.

Online games and contests have existed almost since online networks were created. The first online services available to a user with a personal computer and a modem were bulletin board systems or BBS's. They started appearing in the early 1980's and exploded in popularity along with the growth of the personal computer. The most primitive of these systems allowed users to share files and exchange email. The ability to conduct electronic games was quickly added as enthusiasts joined the systems. Computer enthusiasts usually operated BBS's as a hobby rather than as a commercial enterprise. In the late 1980's, corporations began creating online services that could handle thousands of users simultaneously. Online services such as Prodigy, CompuServe, and America Online brought a new level of professionalism and sophistication to the industry. Inelegant text-based user interfaces were replaced with graphical front ends that no longer required users to memorize arcane commands or codes. Game play became more popular as the software became increasingly user-friendly.

To increase player interest, several companies have begun to offer online contests with cash prizes. Yoyodyne Entertainment provides an email-based trivia game that is available through the Internet and several online services. Players receive questions via email and must submit their answers before a deadline, which is usually a day or two later. Points are awarded for each correct answer and deducted for each incorrect answer. The winner is the person with the highest score at the end of the contest.

Interactive Imaginations also developed online contests for prizes. They created the Riddler site on the World Wide Web. Users are offered a selection of games, including trivia and puzzle games. Like the Yoyodyne site, prize amounts are necessarily limited because there are no entry fees.

Another limitation of the games run by Yoyodyne and Interactive Imaginations is that there is no continuity among the games. The results of one game have no impact on the results of another game. Each game is an independent event; they are not linked together into a more continuous game experience. After registering for one game, the process must be repeated for future games. A player who has become an expert in a trivia game is able to enter the same trivia games again and again, monopolizing the top prizes. Game organizers are unable to prevent this since there are no effective controls on who can register for a game. Games geared exclusively to experts are impossible as there is no effective way to screen the qualifications of participants.

Online games also lack effective reservation systems—players simply log on at the appropriate time and begin play. If game organizers want to restrict the number of players, they are forced to establish an arbitrary limit on the number of entrants. If such a limit is enforced, however, players will have no way to know in advance whether or not they will be able to register at the time the tournament starts.

Some tournaments charge an entry fee or charge every player a certain dollar amount for each game played. Prizes awarded for video tournaments are usually a trophy and a small cash award usually under $200. Some tournaments only offer a rating on a ladder.

It's becoming apparent that the only tournaments that can give players a cash award are those where each player makes a wager and the accrued wagers make up the prize pool. The problems that face these types of tournaments are that they are illegal in most jurisdictions. This limitation among other things also limits the size of the tournament, because wagering across a state line is prohibited for most gaming operations. This would eliminate wager-based tournaments from being played on the Internet, especially in the United States.

All professional sports use an elimination process to make the game more exciting for participants as well as spectators. Professional football, baseball, basketball, and hockey all have regular seasons followed by post-season play in which teams are eliminated from contention. Instead of having a regular season, professional tennis offers a series of games in which the field narrows through a process of elimination until ultimately one competitor remains and is declared the winner. Professional golf tournaments have a cut in which the field is dramatically cut back before the final round of competition begins.

There is a need for an electronic gaming system in which players from different locations can participate in and receive consideration, without violating gambling statutes. The system should not just support stand-alone games, but should also support the coordination of multiple games in which information from one game impacts future games.

### SUMMARY OF THE INVENTION

In accordance with one embodiment of the present invention, a method of conducting an electronic game tournament for a plurality of players is disclosed. The method comprises: providing an electronic game; enabling a plurality of players to participate in the electronic game tournament by playing the electronic game via a communications network; storing in a database player achievements from play of the electronic game, the stored player information being available to place at least one of the plurality of players in one tier of a multi-tier ladder and to thereby qualify the at least one of the plurality of players as a defender of the tier; facilitating play of the electronic game by a challenger against the defender; and compensating at least one of the defender and the challenger in consideration for their services.

In accordance with another embodiment of the present invention, a method of conducting an electronic game tournament for a plurality of players is disclosed. The method comprises: providing an electronic game; enabling a plurality of players to participate in the electronic game tournament by playing the electronic game via a communications network; storing in a database player achievements from play of the electronic game, the stored player information being available to place at least one of the plurality of players in one tier of a multi-tier ladder and to thereby qualify the at least one of the plurality of players as a defender of the tier; facilitating play of the electronic game by a challenger against the defender; elevating a player to a higher tier based on performance criteria; wherein the performance criteria comprises achievements during play of the electronic game by the player; and compensating the at least one of the defender and the challenger in consideration for their services; wherein the step of compensating the defender in consideration for their services includes awarding increasingly higher consideration for higher play by the defender at higher tier levels.

In accordance with still another embodiment of the present invention, a multi-player electronic gaming tournament system is disclosed. The system comprises: a ladder comprising a plurality of tiers, each tier corresponding to a different level of play; an electronic game; and a communications network; wherein a plurality of players are ranked into one or more of the plurality of tiers on the ladder based upon at least one achievement during play of the electronic game via the communications network; and wherein one or more of the plurality of players receive consideration via the communications network for successfully defending against one or more other players in at least one of the same or lower tier of the ladder.

### BRIEF DESCRIPTION OF THE DRAWINGS

FIG. 1 is a block diagram, illustrating a communications network that may be utilized in connection with systems and methods consistent with embodiments of the present invention.

FIG. 2 is an illustration of a ladder type of ranking system, which may be utilized in connection with systems and methods consistent with embodiments of the present invention.

FIG. 3 is an illustration of a ladder type of ranking system having multiple ladders, which may be utilized in connection with systems and methods consistent with embodiments of the present invention.

FIG. 4 is an illustration of a playoff between winners of multiple ladders, which may be utilized in connection with systems and methods consistent with embodiments of the present invention.

### DETAILED DESCRIPTION OF THE PREFERRED EMBODIMENTS

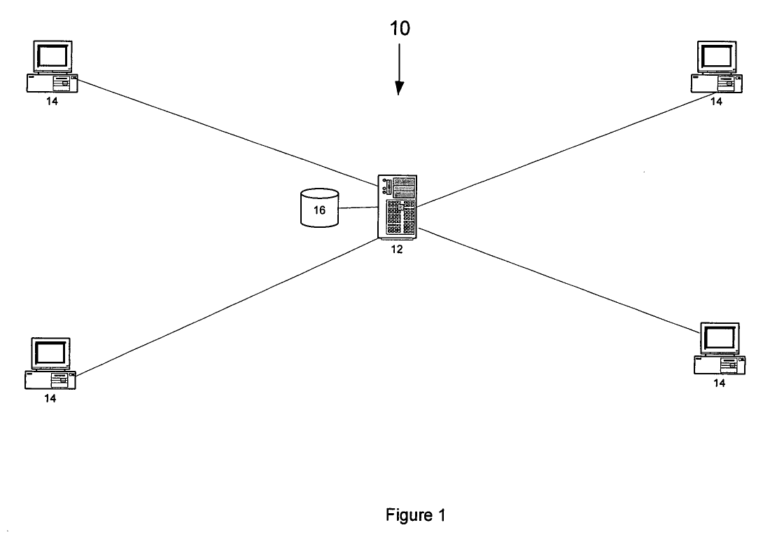

Referring initially to FIG. 1, it should be noted initially that an object of the present invention is to provide methods of playing electronic game tournaments via a communications network 10, such as the Internet. In one embodiment, a server 12 is in communication with a plurality of player terminals 14. The player terminals 14 may be any combination of desktop computer(s), laptop computer(s), dedicated gaming terminal(s), telephone, PDA, or other desired hardware. Communication may be wired, wireless, or some combination thereof.

Consistent with the present invention, these tournaments can be played more or less entirely over the communications network 10, with no two players being physically located in the same room. Alternatively, a plurality of players, or even all of them, may be physically present together in a location where, at a minimum, the player terminals 14 are present.

Any type of competitive game(s) can be utilized in practicing the method and system of the present invention. That would include, but not be limited to, video games. Some of the more popular current manufactures of video games are: Game boy, Game cube PC Games Play Station2, Microsoft X-Box, Nintendo, Atari, Sega, Konami, Bally, Williams, and Yahoo!.

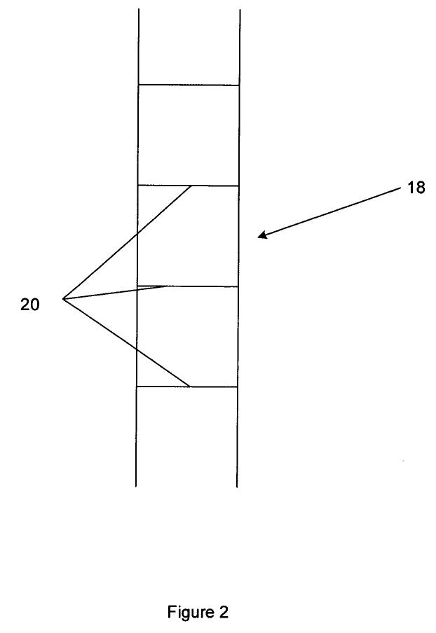

It is preferred to organize the players, as play progresses, into a ranking system. An example of a preferred ranking system, as shown in FIG. 2, would be a ranking ladder 18 having multiple ascending tiers 20. In a system of this type, a player begins at the lowest tier 20, or even at no tier 20, and seeks to ascend the tiers 20 of the ladder 18. The player is able to ascend based on performance, as described in more detail below. (It should be noted that it may be desired to also provide that a player is able to descend, based on poor performance, lack of play, or other criteria.)

In one embodiment, the participants in the present invention are categorized as “challengers” and “defenders.” In the preferred embodiment, the challenger will participate against a live person designated as a defender. It should be noted the defender need not be a live person, but instead could be a computerized device or the like, so that a challenger in such instance would be playing against a machine rather than a person.

In general, according to this embodiment, the challenger utilizing a terminal 14 will activate the play of the game against a defender also utilizing a terminal 14. Game activation may be executed monetarily by payment of a participation fee, provision of game credits, or by other means. It should be noted that it may be desired to permit play to be activated other than by a challenger. For example, it may be desired to have the server 12 communicate the pairing of a challenger and a defender, and further to require that they play at or by a certain date and time. It is preferred that the challenger activates play.

In one embodiment, the defender will receive compensation for playing against the challenger and/or for defeating the challenger. Preferably, compensation will be provided pursuant to a pay schedule or the like, and preferably will be communicated by the server 12 over the network 10. The compensation may be monetary, or may take some other form, such as the provision of goods, services, discounts, credits, etc. There may be other means of compensation to the defender than payment according to a pay schedule

The requirements for receiving compensation can be varied as desired. For example, a defender could receive compensation for every game played against a challenger, whether the defender wins or loses. It may be desired to provide that a defender is compensated only for defeating a challenger. It may also be desired to provide that a defender is compensated for playing against a certain number of challengers, for playing a certain amount of time, for achieving certain scores, and so on. In general, it would be preferred to set forth the compensation formula in a set of rules of the game or the like that are disclosed to the players in advance of play.

In one embodiment, the challenger's goal is to achieve a designated number of wins against a designated number of defenders, and/or to demonstrate one or more skill sets during play—any one of which, or their like, might be regarded as a player achievement. Upon such achievement, the challenger may advance to a first level tier 20 or, if the challenger is placed on the first level 20 or other tier at the beginning of the tournament, then the challenger may progress to the next higher tier 20. (It should be noted that it may be desired to provide within the rules of play criteria, according to which a challenger can skip tiers—for example, by achieving a certain score during play of a game against a defender.) After advancing, the challenger becomes a defender of the new tier. Once a challenger becomes a defender, that player may qualify to receive compensation as a defender, as described above.

Preferably, results of play, which may be utilized for ranking and compensation purposes, as described herein, are maintained at database 16, which is in communication with server 12.

It should be noted that, in one embodiment, players may be either challengers or defenders, depending on the particular match in which they are participating. In general, a player is a defender when playing a challenger from a lower tier. A player is a challenger when playing a defender from a higher tier. (It may be desired to provide that a player can challenge a player on the same tier, and to further provide that, in such instance, the challenging player is the challenger, and the defending player is the defender.) Once the player achieves the first level tier and becomes a defender of that tier, he may become qualified to challenge defenders on the next tier, and so on. It may be desired to permit, in some instances, a challenger to skip over one or more tiers and challenge defenders ranked on tiers that are higher than the next tier.

While generally it is contemplated that a challenger would challenge a higher ranked player, it may be desired to permit challengers to challenge players in their same tier 20. It may also be desired to permit a higher ranked player to challenge a lower ranked player, for example where the lower ranked player has achieved a winning reputation. The impact of such matches on the ranking of either player may be established as desired.

In one embodiment, the challenger may be rated according to the outcome of one or more matches against a defender, and/or demonstration of the acquisition of one or more skill sets, including for example achieving at or above a certain score. Preferably, such information is stored at database 16, and the rating is executed by server 12 and communicated as necessary to player terminals 14. The defender may also be rated based on match outcome and/or skill set acquisition.

In one embodiment, a challenger may challenge a specified defender. (It should be noted that players may use their real names or, perhaps more likely, screen names or handles.) It may also be desired to provide that a challenger is randomly matched to a defender.

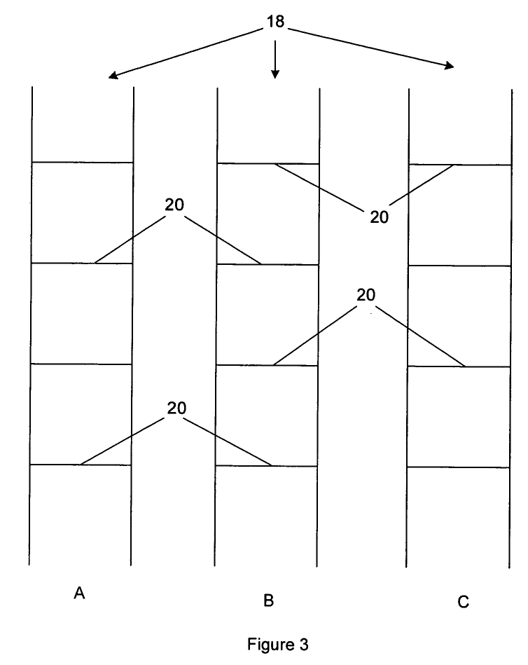

Referring now to FIG. 3, in one embodiment, at least two ladders 18 (in this example, three ladders 18) are provided. Each such ladder 18 has multiple tiers 20, as described herein. In order to accommodate significant numbers of players or for other reasons, it may be desired to have multiple ladders 18. Assignment to a particular ladder 18 may be based on the number of players participating (e.g., the first 1,000 players are assigned to ladder A, the second 1,000 to ladder B, the third 1,000 to ladder C, and so on). It may be based on geographical considerations (e.g., residents of Nevada are assigned to ladder A, residents of Arizona are assigned to ladder B, residents of California are assigned to ladder C, and so on.) Assignment may also be based on any other desired factor.

In one embodiment, play across ladders 18 may be facilitated. It may be desired to provide that such play can occur, but that the respective challengers and defenders remain within their ladder 18 and the results of player and/or demonstration of skill sets during such play are used for ranking purposes within one or both player's existing ladder. It may be desired to permit a player to hold rankings on more than one ladder 18, or to jump from one ladder to another. Challenges from one ladder 18 to another may be incentivized by the compensation provided the challenger and/or defender for participating in such a game.

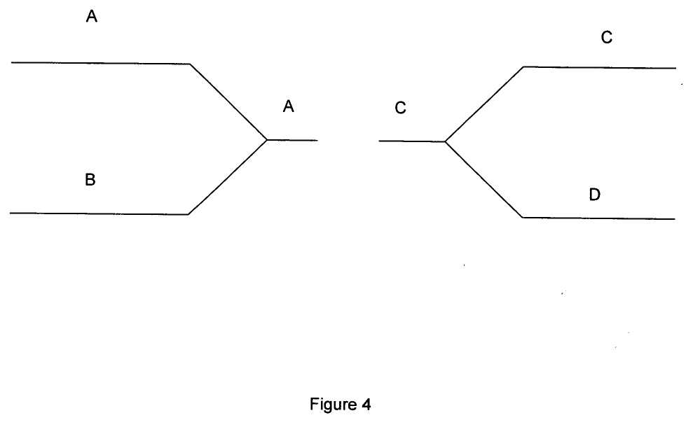

Referring now to FIG. 4, the use of multiple ladders 18 would permit the organization of player into a playoff type of structure. For example, assuming there are four ladders A, B, C and D, and treating each ladder as a conference, and then treating the top player on one ladder as the conference champion, it may be desired to facilitate play between ladder champions as part of the play of a multi-ladder playoff. Where there are a sufficient number of ladders, it may be desired to provide a playoff of ladder champions, with successful champions progressing from round to round within such a playoff until an overall winner is declared. In this example, the winner of ladder A plays the winner of ladder B, and the winner of ladder C plays the winner of ladder D, and then the two winners of the first round (in this example, A and C) play each other in a championship match. Compensation may be provided to the overall winner and, if desired, to players at one or more of the other levels of such a playoff.

To the extent that game play occurs via a network where the players are not physically located in the same facility, there may be a concern that cheating may occur, where, for example, a more skilled player takes the place of a less-skilled defender. It may therefore be desirable to provide security features intended to thwart such activity. For example, it may be desired to incorporate a video cam into player terminals 14. This would allow the tournament operators to verify that a registered player is actually the person that is playing the game, and may also be used to allow the players to see who they are playing against. (If the cam has a sufficient panoramic lens, it would also afford a view of the hands of the players, to verify that the player who is being viewed on the cam is actually doing the playing.) Other security devices, such as retina scans, fingerprinting, face recognition technology, etc., may also be used to provide security.

In one embodiment, where game play occurs over a network such as the Internet, it may be desired to permit players to log on to a particular web-site for purposes of game play according to one or more of the embodiments described herein. It may also be desired to permit players to log on to a second web-site, where play of electronic games other than in accordance with an embodiment of the present invention is possible, and permit a player at that second site from selecting a tournament option, whereby that player may qualify for ranking, compensation, challenger/defender status, and so on as set forth herein. In this fashion, it can be seen that one or more of the embodiments of the present invention can be made to overlay a prior art web-site, or the like, wherein electronic games are played by multiple players via a network without the benefit of a tournament, compensation, ratings structure as described herein.

1. A method of conducting an electronic video game tournament for a plurality of players, comprising the steps of:
providing an electronic video game;
enabling a plurality of players to participate in the electronic video game tournament by playing the electronic video game via a communications network;
storing in a database player scores from play of the electronic video game, the stored player information being available to place at least one of the plurality of players in one tier of a multi-tier ladder and to thereby qualify the at least one of the plurality of players as a defender of the tier;
facilitating play of the electronic video game by a challenger against the defender; and
compensating the defender in consideration for their services.

2. The method of claim 1, wherein the defender comprises at least one computer.

3. The method of claim 1, wherein the defender comprises at least one live person.

4. The method of claim 1, further comprising elevating the defender to a higher tier based on predetermined performance criteria.

5. The method of claim 4, wherein the predetermined performance criteria comprises a prescribed number of victories during play of the electronic video game by the defender.

6. The method of claim 1 wherein the step of compensating the defender in consideration for their services includes awarding increasingly higher consideration for play at higher tier levels.

7. The method of claim 1, further comprising enabling acceptance of fee from the challenger.

8. A method of conducting an electronic video game tournament for a plurality of players, comprising the steps of:
providing an electronic video game;
enabling a plurality of players to participate in the electronic video game tournament by playing the electronic video game via a communications network;
storing in a database player scores from play of the electronic video game, the stored player information being available to place at least one of the plurality of players in one tier of a multi-tier ladder and to thereby qualify the at least one of the plurality of players as a defender of the tier;
facilitating play of the electronic video game by a challenger against the defender;
elevating the defender to a higher tier based on predetermined performance criteria;
wherein the predetermined performance criteria comprises a prescribed number of victories during play of the electronic video game by the defender; and
compensating the defender in consideration for their services;
wherein the step of compensating the defender in consideration for their services includes awarding increasingly higher consideration for higher play by the defender at higher tier levels.

9. A multi-player electronic video gaming tournament system comprising:
a ladder comprising a plurality of tiers, each tier corresponding to a different level of play;
an electronic video game; and
a communications network;
wherein a plurality of players, including at least one challenger and at least one defender, are capable of playing the game over the communications network:
wherein the at least one defender is ranked into one or more of the plurality of tiers on the ladder by achieving a predetermined scoring threshold during play of the electronic video game via the communications network; and
wherein the at least one defender receives consideration via the communications network for successfully defending against the at least one challenger in at least one of the same or lower tier of the ladder.

10. The multi-player electronic video gaming tournament system of claim 9, further comprising at least two ladders.

11. The multi-player electronic video gaming tournament system of claim 9, wherein the plurality of players achieve the predetermined scoring threshold based on skill.

12. The multi-player electronic video gaming tournament system of claim 11, wherein the plurality of players achieve the predetermined scoring threshold based on outscoring one or more other players.

13. The multi-player electronic video gaming tournament system of claim 9, wherein the at least one defender who receives consideration progresses to a higher tier within the ladder upon successfully defending against the at least one challenger.

14. (canceled)

15. The multi-player electronic video gaming tournament system of claim 9, wherein the at least one challenger provides a fee in exchange for participating in the electronic video game against the at least one defender.

16. The multi-player electronic video gaming tournament system of claim 9, wherein at least a portion of the defenders comprise computers.

17. The multi-player electronic video gaming tournament system of claim 9, wherein the consideration to one or more defenders includes increasingly larger consideration for higher tier plays.

18. The multi-player electronic video gaming tournament system of claim 9, wherein the one or more winning players may advance in the same tier or to a higher tier by achieving a predetermined number of wins against a predetermined number of other players.

19. The multi-player electronic video gaming tournament system of claim 10, wherein one or more challengers challenge one or more defenders in a different ladder.

20. The multi-player electronic video gaming tournament system of claim 9 further comprising a video game controller with security devices including one or more of a unique user name and password, a video cam and fingerprint or recognition technology.

21. The multi-player electronic video gaming tournament system of claim 10, wherein the at least one defender is permitted to challenge at least one other defender in a different ladder to the play of the electronic video game over the network.

22. The multi-player electronic video gaming tournament system of claim 10, wherein the at least one challenger is permitted to play at least one other challenger in a different ladder to the play of the electronic video game over the network.

23. A method of conducting an electronic video game tournament for a plurality of players, comprising the steps of:
providing an electronic video game;
enabling a plurality of players to participate in the electronic video game tournament by playing the electronic video game via a communications network;
storing in a database player scores from play of the electronic video game;
wherein the stored player information is available to place at least one of the plurality of players in one tier of a first multi-tier ladder and to thereby qualify the at least one of the plurality of players as a defender of at least one of the tier and the first ladder;
wherein the stored player information is available to place the defender in one tier of a second multi-tier ladder and to thereby qualify the defender as a defender of at least one of the tier and the second ladder;
facilitating play of the electronic video game by a challenger against the defender; and
compensating the defender in consideration for their services.

24. The method of claim 23, wherein the defender comprises at least one live person.

25. The method of claim 23, further comprising elevating the defender to a higher tier in at least one of the first and second ladder based on predetermined performance criteria.

26. The method of claim 25, wherein the predetermined performance criteria comprises a prescribed number of victories during play of the electronic video game by the defender.

27. The method of claim 23 wherein the step of compensating the defender in consideration for their services includes awarding increasingly higher consideration for play at higher tier levels.

28. The method of claim 23, further comprising enabling acceptance of a fee from the challenger.
